(19) United States
(12) Patent Application Publication
(10) Pub. No.: US 2003/0116251 A1
(43) Pub. Date: Jun. 26, 2003

(54) Method for the production of a pipe section for insertion in a damaged pipeline or channel after the relining process

(75) Inventors: Jurgen Allmann, Kirn (DE); Edwin Baumann, Kirn (DE); Richard Spengler, Kirn (DE)

Correspondence Address: DARBY & DARBY P.C., Post Office Box 5257, New York, NY, 10150-5257, US

(73) Assignee: SIMONA AG

(21) Appl. No.: 10/260,000

(22) Filed: Sep. 24, 2002

Related U.S. Application Data
(63) Continuation of application No. PCT/EP01/03347, filed on Mar. 23, 2001.

(30) Foreign Application Priority Data
Mar. 24, 2000 (DE) DE100 14 653.8

(51) Int. Cl. B31B 1/60

(52) U.S. Cl. 156/60

(57) ABSTRACT

The invention relates to a method for the production of a pipe section (2), for insertion in a damaged pipeline or channel after the relining process, comprising an essentially cylindrical pipe section (4), with a collar end-piece (10) and an end (16), which may be introduced in the collar end-piece of an adjacent, corresponding pipe section. The invention is characterised in that the essentially cylindrical pipe section (4) is produced by winding a flat material (32) around a core (34) and formed by seam- or butt-welding or similar, or for a non-circular tube profile produced by means of shaping and, optionally, subsequent sectioning. The collar end-piece (10) is produced by partial sliding of a suitable pre-formed separate collar ring (8) onto one end (6) of the essentially cylindrical pipe section (4) and subsequent fixing to the above by means of fillet or socket welding.

The invention concerns a method in accordance with the precharacterizing portion of claim 1.

A pipe section of the type described therein is known from DE 298 18 296.3-U1 as a single-piece molded plastic article with an approximately oval profile, which may be injection-molded, cast (preferably rotationally molded) or essentially extruded. In one embodiment, this pipe section has a collar end-piece protruding radially outward past the essentially cylindrical pipe segment, and, on its exterior surface, a number of so-called spacers and anchors extending radially outward equally as far, whose purpose, firstly, is to produce a uniform spacing between the outer wall of the essentially cylindrical pipe segment and the inner wall of the surrounding pipeline or surrounding channel, and secondly to produce bracing in a filling compound that otherwise fills the relevant interspace, chiefly in order to stabilize the relatively flat side walls of the cylindrical pipe segment.

Such pipe sections fulfill their purpose in an entirely satisfactory manner, but they are relatively expensive to manufacture. Above all, their manufacture requires suitably large equipment, some of which is customized to the specific pipe size and shape.

Consequently, the object of the invention is to specify a method for the production of a pipe section in accordance with the precharacterizing portion of claim 1 which is cheaper and also can be carried out economically with essentially conventional equipment.

This object is attained in accordance with the invention by the characterizing features of claim 1. The dependent claims specify further advantageous configuration options.

As a result of the fact that the essentially cylindrical (but generally not circular cylindrical) pipe segment is produced from flat stock by seam or butt welding, or by forming from an ordinary, circular cylindrical pipe profile, and the collar ring is subsequently applied thereto as a separate piece, it is possible to use simple, conventional manufacturing steps and correspondingly simple, multipurpose equipment.

Preferred example embodiments of the claimed method are described in more detail below on the basis of the accompanying drawings. These show:

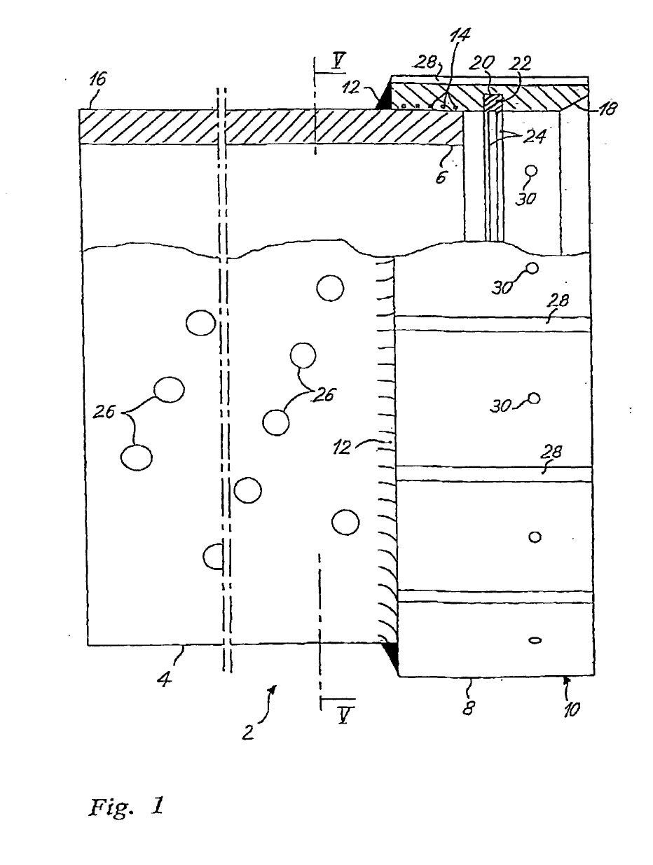

FIG. 1 a partially cross-sectional side view of a pipe section produced in accordance with the invention,

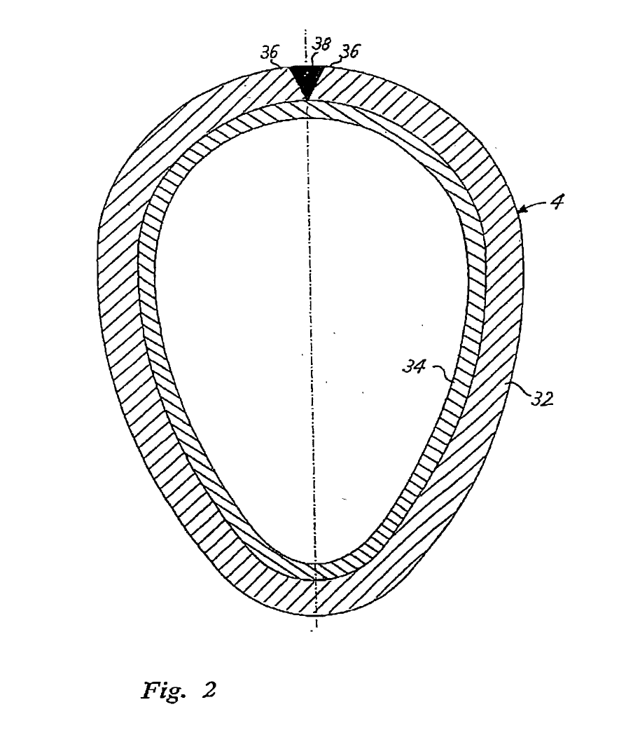

FIG. 2 a schematic diagram of the manufacture of the relevant cylindrical pipe segment of curved flat stock,

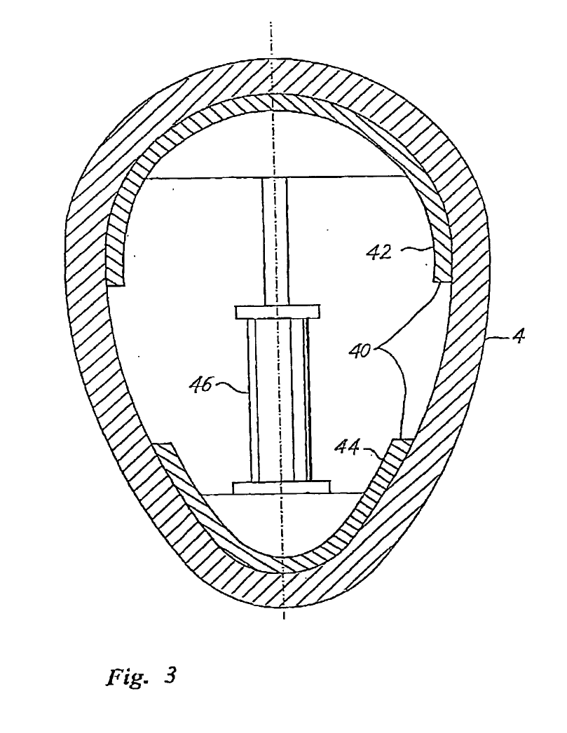

FIG. 3 a schematic diagram of the manufacture of the cylindrical pipe segment by forming from a different—generally circular—pipe profile

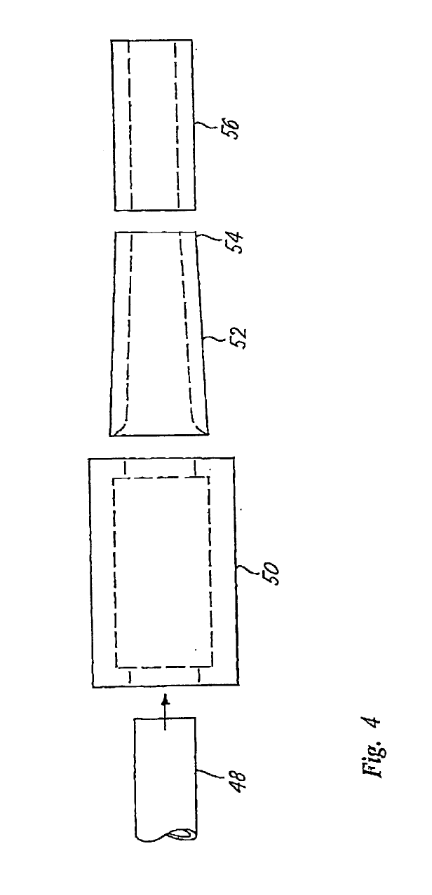

FIG. 4 a schematic diagram of a forming system for obtaining the cylindrical pipe segment that operates continuously at least at times, and

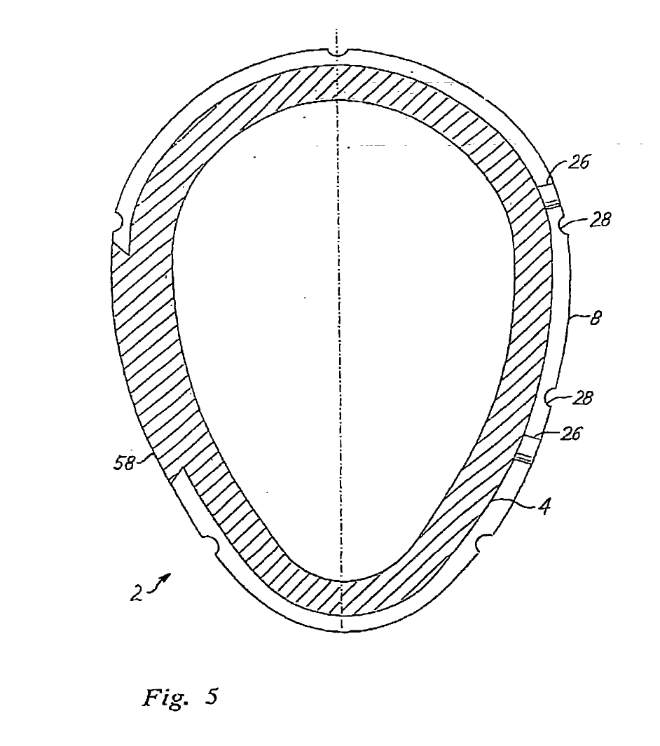

FIG. 5 a cross-section through the pipe section from FIG. 1 from approximately the plane of line V-V in FIG. 1, wherein the left half shows another variant.

The pipe section 2 shown in its entirety in FIG. 1 consists essentially of a cylindrical pipe segment 4 and a collar ring 8 overlapping an end 6 of the same to form a collar end-piece 10 of the pipe section 2. The two parts, 4 and 8, are made of thermoplastic material, preferably polyethylene and if so the types designated PE 80 or PE 100 per DIN 8074/8075 are advantageous, or polypropylene and if so the types designated PP-H 100, PP-B 80 or PP-R 80 per DIN 8077/8078 are advantageous, or polyvinylidene fluoride (PVDF), or of a multilayer composite of such plastics.

As shown in FIG. 1, the collar ring 8 is pushed partway onto the cylindrical pipe segment 4 and affixed thereto by means of a fillet weld 12, although socket welding, especially electric socket welding, could be used in place of the fillet weld 12 when a sacrificial electric heating coil is used, as indicated at 14 in FIG. 1. Such socket welds are known and customary in the plastic piping field.

The collar end-piece 10 serves only to accommodate the free end 16 of the cylindrical pipe segment 4 of just such an adjoining pipe section (not shown), which in the piping field is also called a “spigot end” even though this end need not be pointed or even chamfered, which is also true of the end 6 enclosed by the collar ring 8. Instead, the collar ring 8 has at its exposed end an internal chamfer 18 in order to facilitate introduction of the end 16 of the adjoining pipe section, which otherwise fits closely into the collar ring 8.

Nevertheless, it is useful to provide inside the collar ring 8, as shown, a ring groove 20 that accommodates a lip seal 22 made of an elastomer with two mutually parallel lips 24 that contact and seal against the inserted end 16 (spigot end) of the adjoining pipe section. Instead of being inside the collar ring 8, the groove 20 with the lip seal 22 could also be provided on the outside of the free end 16 of the cylindrical pipe segment 4. Alternatively, a heating spiral (not shown) for electric socket welding of the consecutive pipe sections can also be provided in the collar end-piece 10 or on the end 16, in which case the ring groove 20 with the lip seal 22 can be omitted.

As FIG. 1 also makes clear, the outer wall of the cylindrical pipe section 4 is provided with a series of circular projections 26, which perform the same function as the so-called anchors 4 in DE-298 18 296.3-U1, this being chiefly to anchor the relatively flat sides of the cylindrical pipe segment 4 in a filling compound that ultimately will surround it.

In order to introduce such a filling compound from the collar end-piece 10 of the laid pipe section 2, a plurality of axial grooves 28 are provided at intervals in the outer wall of the collar ring 8. Then the collar ring 8 also has, in the example shown, a number of bores 30 that run vertically to its wall and are arranged in a ring to accommodate self-tapping screws in order to affix the collar end-piece 10 to the end 16 of the adjoining pipe section with regard to tensile forces (“longitudinally positive”). Of course, in the event of socket welding, the bores 30 can also be omitted.

There are several different manufacturing methods for manufacturing the cylindrical pipe segment 4. Firstly, it can be produced as shown in FIG. 2, by bending an originally flat sheet 32 about a core 34 and then seam welding along the adjoining edges 36. In FIG. 2, a V-shaped extrusion weld seam 38 is shown in this location. Of course, a butt weld seam (not shown) could also appear in its place, as can be produced in known manner after the intermediate introduction of a so-called heating mirror by butting together the edges that were preheated thereby.

Instead of flat stock in sheet form, the cylindrical pipe segment 4 could also be produced in a manner that is known per se as helical tube from a strip of flat stock wound in a spiral about the core 34 that is then welded or melted at its longitudinal edges, and finally cut into lengths (not shown).

As in FIG. 3, the cylindrical pipe segment 4 is produced with a non-circular profile, such as the egg-shaped profile shown, by forming from ordinary, initially circular cylindrical pipe material and, if necessary, subsequent cutting to length. To this end, an axially divided core 40 is used, whose two parts 42 and 44 are curved appropriately for the two crowns of the desired profile. The two parts 42 and 44 can be spread apart by means of at least one pneumatic or hydraulic cylinder 46 in order to thus obtain the laterally flattened profile shape. A wedge-shaped slide, an inflatable hose, or the like could also take the place of the cylinder 46. In like manner, such a hose could replace the core 40, as long as the desired contour of the tube segment 4 is provided from the outside by an appropriate sheathing. Finally, jaws that act from the outside could also be used in place of the two interior core parts 42 and 44 to act on the ultimately flat sides of the profile in order to obtain the desired oval shape or the like.

All these shaping or forming processes are usefully carried out in a hot state. Otherwise, or in addition, a final heating may be desirable to relieve stresses that have arisen.

Finally, FIG. 4 illustrates a forming method for obtaining a noncircular pipe profile from a circular one that operates continuously at least at times to produce the cylindrical pipe segment 4 in FIG. 1. According to this method, an ordinary, round cylindrical pipe profile 48 is first guided through a tunnel oven 50 and then axially through a shaping channel 52, which increasingly assumes the desired profile shape toward its outlet end 54.

As shown, it can be useful in this context to have a cylindrical cooling channel 56 follow the shaping channel 52, where the formed pipe profile can solidify while maintaining the profile shape it has been given.

In this way, profile sections of practically any desired length can be produced, which can then be cut to length into the desired pipe segments 4 in any customary way.

Moreover, the associated collar rings 8 can also be formed in the same way as the cylindrical pipe segments 4 thus formed, especially when the pipe section 2 to be produced does not have a circular profile.

FIG. 5 also shows, in addition to the circular projections 26 that can be seen in FIG. 1 on the outer wall of the cylindrical pipe segment 4, a relatively large-area projection 58 that has undercuts on its edge—either as an alternative to or in addition to cylindrical projections 26. All these projections serve primarily to stabilize the relatively flat sides of the cylindrical pipe segment 4 and to maintain its spacing from the inner wall of the surrounding damaged pipe or channel. As can be seen, to this end they have the same height as the collar ring 8 with respect to the outer wall of the pipe segment 4.

It is beneficial for the projections 58 and 26 to be applied after the fact to the otherwise finished cylindrical pipe segment 4; this can be accomplished by friction welding, and in the case of the round projections 26, preferably by rotational friction welding. When the cylindrical pipe segment 4 is produced from flat stock in sheet form, this material can of course also already have or be provided with the projections, especially 26.

The pipe section 2 obtained with all the above-mentioned variants of the production process in accordance with the invention is comparable in all respects to that from DE 298 18 296.3 U1, yet in many cases it can be produced more simply and also can be produced economically in greater variety. Thus, it can easily be provided with any desired profile shapes, such as that of a jaw profile, in addition to any desired lengths and thicknesses.

1. Method for the production of a pipe section (2) for insertion in a damaged pipeline or channel after the relining process that has an essentially cylindrical pipe segment (4) with a collar end-piece (10) and an end (16), which may be introduced into the collar end-piece of an adjoining, corresponding pipe section, characterized in that the essentially cylindrical pipe segment (4) is produced by winding a flat material (32) around a core (34) and formed by seam or butt welding or similar, or for a non-circular pipe profile, is produced from a circular profile by means of forming, and, optionally, subsequent cutting to length, and in that the collar end-piece (10) is produced by pushing a suitable, separately produced collar ring (8) partway onto an end (6) of the essentially cylindrical pipe segment (4) and subsequently affixing it thereto by means of fillet or socket welding.

2. Method in accordance with claim 1, characterized in that the essentially cylindrical pipe segment (4) is produced from a sheet material (32) bent in a plane normal to the axis.

3. Method in accordance with claim 1, characterized in that the essentially cylindrical pipe segment (4) is produced from a strip material wound in a spiral about a core (34).

4. Method in accordance with claim 1, wherein the essentially cylindrical pipe segment (4) is produced by forming, characterized in that the forming is carried out by means of an expandable core (40) or an inflatable hose.

5. Method in accordance with claim 1, wherein the essentially cylindrical pipe segment (4) is produced by forming, characterized in that the forming is carried out by means of laterally applied jaws.

6. Method in accordance with claim 1, wherein the essentially cylindrical pipe segment (4) is produced by forming, characterized in that the forming is carried out continuously in the course of a longitudinal motion of an initially circular cylindrical pipe profile and in that, if desired, subsequent cutting to length takes place.

7. Method in accordance with one of the preceding claims, characterized in that, inside the collar end-piece (10) or outside the free end (16) of the cylindrical pipe segment (4), a circumferential groove (20) is produced into which is placed a ring-shaped lip seal (22) of an elastomeric material.

8. Method in accordance with one of the preceding claims, characterized in that a heating spiral for electric socket welding is placed in the inner wall of the collar end-piece (10) or the outer wall of the free end (16) of the cylindrical pipe segment (4).

9. Method in accordance with one of the preceding claims, characterized in that the essentially cylindrical pipe segment (4) is provided on its outside with projections (26, 58), whose height preferably corresponds to the wall thickness of the collar ring (8).

10. Method in accordance with claim 9, characterized in that such projections (26) have an essentially circular cylindrical shape.

11. Method in accordance with claim 9 or 10, characterized in that such projections (58) have undercuts.

12. Method in accordance with one of the preceding claims, characterized in that the relevant pipe section (2), with the exception of a possible lip seal (22), heating spiral (14), or the like, is made entirely of thermoplastic material, preferably polyethylene, particularly the types designated PE 80 or PE 100 per DIN 8074/8075, or polypropylene, particularly the types designated PP-H 100, PP-B 80 or PP-R 80 per DIN 8077/8078, or polyvinylidene fluoride (PVDF), or of a multilayer composite of such plastics.

13. Method in accordance with one of claims 9 through 11 in conjunction with claim 12, characterized in that the projections (26, 58) are applied by friction welding.

14. Method in accordance with one of the preceding claims, characterized in that the at least one external longitudinal groove (28) is placed in the collar ring (8) before or after application to the essentially cylindrical pipe segment (4).

15. Method in accordance with one of the preceding claims, characterized in that bores (30) normal to the wall are made in the collar end-piece (10) to accommodate screws in order to affix the collar end-piece to the end (16) of an adjacent pipe section (2) that is to be introduced therein.
